(19) United States
(12) Patent Application Publication
(10) Pub. No.: US 2008/0264746 A1
(43) Pub. Date: Oct. 30, 2008

(54) Latching Linear Actuator

(75) Inventors: William Simpson, West Midlands (GB); Anthony James O'Neill, West Sussex (GB)

Correspondence Address: DORITY & MANNING, P.A., POST OFFICE BOX 1449, GREENVILLE, SC, 29602-1449, US

(73) Assignee: RICARDO UK LTD, WEST SUSSEX (GB)

(21) Appl. No.: 12/090,299

(22) PCT Filed: Oct. 16, 2006
(86) PCT No.: PCT/GB2006/003832

§ 371 Date: Jul. 11, 2008

(30) Foreign Application Priority Data
Oct. 17, 2005 (GB) 0521036.4

(51) Int. Cl. F16D 25/0638

(52) U.S. Cl. 192/3.33

(57) ABSTRACT

A linear actuator, suitable for a clutch (5, 6) of a motor vehicle transmission, has a bi-stable latch mechanism (18, 20) adapted to maintain an actuating member (26) in one of two positions on the output axis. Repeated applications of fluid pressure cause the actuator to alternate between the bi-stable states, and may thus cause a clutch to alternate between engaged and disengaged conditions.

This invention relates to linear actuators, particularly latching actuators for clutches associated with rotating mechanisms in machinery.

Linear actuators provide an advancing and retracting motion, typically in response to the presence or absence of a fluid pressure.

A clutch is often provided in machinery to permit engagement and disengagement of a drive, typically to permit torque transmission on demand. Such a clutch may be operated by a linear actuator. In this specification the term ‘clutch’ comprises any such selectively engageable device, including those which may be recognised by an alternative name.

An example of the use of such clutches is provided by an automatic vehicle transmission of the hydraulic/epicyclic kind. This kind of transmission comprises a plurality of linked epicyclic gear trains, the relatively rotating parts thereof being selectively restrained so as to provide different input/output speed ratios. These parts may be restrained against each other, or be grounded on the transmission casing, and for this purpose disengageable clutches are provided. Some clutches may be in the form of brake bands engageable on an annulus of an epicycle gear train.

In order to actuate such clutches, a source of hydraulic fluid is provided, under pressure from an engine or transmission driven pump. A suitable valve system and governor directs the fluid to selected clutches, in order to give a required speed ratio.

Typically the clutches are disengaged in the non-pressurised state; that is to say fluid pressure is used to engage the clutch, and to hold the clutch engaged. The absence of fluid pressure allows the clutch to release, and a suitable spring return force may be provided to assist disengagement.

One problem with such a transmission is that fluid must be maintained under pressure in actuators associated with engaged clutches, and hence the parasitic energy consumption is high compared with manual arrangements in which moving elements are latched by detents.

What is required is means of reducing or eliminating such parasitic losses whilst avoiding a requirement for additional devices or control elements. A solution would preferably provide automatic latching and de-latching, whilst using substantially the same actuator in substantially the same external envelope.

According to the invention, there is provided a fluid actuator comprising a housing, a fluid chamber, and an actuating member adapted to advance in the housing on an axis in response to a change of fluid pressure within said chamber, said actuator further including a bi-stable latch defining two sequential return positions of said actuating member, said latch switching states on advancing movement to a pre-determined position.

Preferably the actuator includes resilient means to bias the actuating member to a return position. Thus in use the actuator advances against such bias, and is preferably under an initial pre-load.

The bi-stable latch allows the actuating member to adopt one of two sequential and axially spaced positions as it returns to rest. These positions may correspond to active and inactive conditions of a two-state component, such as a clutch of a transmission. The actuating member may for example act upon a clamping member of a clutch, such as a pressure plate for a driven plate. In a preferred embodiment the actuator is co-axial with the rotational axis of the clutch.

In a preferred embodiment, the bi-stable latch comprises an input member, an output member, and a light spring to bias said input member and output member together, wherein said input member and output member have interengaging teeth adapted to permit relative rotation by uni-directional ratcheting, each ratcheting step corresponding to one or other conditions of said bi-stable latch. Unidirectional ratcheting may for example be provided by suitably angled flank faces of the teeth of the input and output members, these faces being in direct opposition, and the other faces of the teeth being in generally radial planes around said axis.

Preferably the housing is circular about said axis, and said input and output member comprise rings within said housing, said rings and housing having an anti-rotation formation, and said output member being disengaged from said formation at the pre-determined position of said actuating member. In a preferred embodiment the housing is an open-mouthed drum having internal splines engageable with external teeth of said rings, the spline pitch corresponding to half the ratcheting distance of said rings. The splines permit axial movement of the rings along the axis and have a length adapted to allow disengagement of the output ring so that relative ratcheting rotation is permitted. Ratcheting by half a spline pitch allows the output ring to alternately be biased into the splines and to be lodged on the end of the splines in a relatively advanced condition.

Preferably, in the most retracted of said return positions said actuating member is biased against said housing via said input member, and in the most advanced of said return positions said actuating member is biased against said housing via said output member. Thus the housing reacts the return load exerted by the resilient means, through one or other of the input and output members.

In the preferred embodiment a Belleville spring acts as the resilient return means for the actuating member, whereas the output member is biased against the input member by a relatively light coil compression spring. The springs are preferably axially co-extensive to a substantial extent.

The drum-like housing may further include a clutch driven plate therein and adapted for an output on said axis. The clutch may be a multi-plate clutch having interleaved driven and driving plates within said drum and retained by a suitable circlip at the mouth thereof. The driving plates may for example be splined to the internal surface of the drum to permit relative axial clamping movement towards said mouth.

In the preferred embodiment the end wall of a drum-like housing defines with the side wall the fluid chamber, and a piston or diaphragm is provided in the chamber to transmit axial motion to the actuating member. A piston may be arranged to act directly on the input member of the bi-stable latch.

Thus, the invention allows repeated application of pressure pulses to sequentially engage and disengage a component such as a clutch. In relation to clutches of automatic vehicle transmissions, the parasitic losses are eliminated since clamping pressure can be maintained in one of the bi-stable states without the presence of fluid pressure. Furthermore the components are able to be contained within a typical clutch housing, and thus external latches and the like are avoided.

The invention is highly suitable for modulating mechanisms in which no intermediate actuator state is required. A particularly important feature is that uni-directional repeating motions cause the actuator to alternate between the bi-stable states.

One feature of the invention will be apparent from the following description of a preferred embodiment shown by way of example only in the accompanying drawings in which:

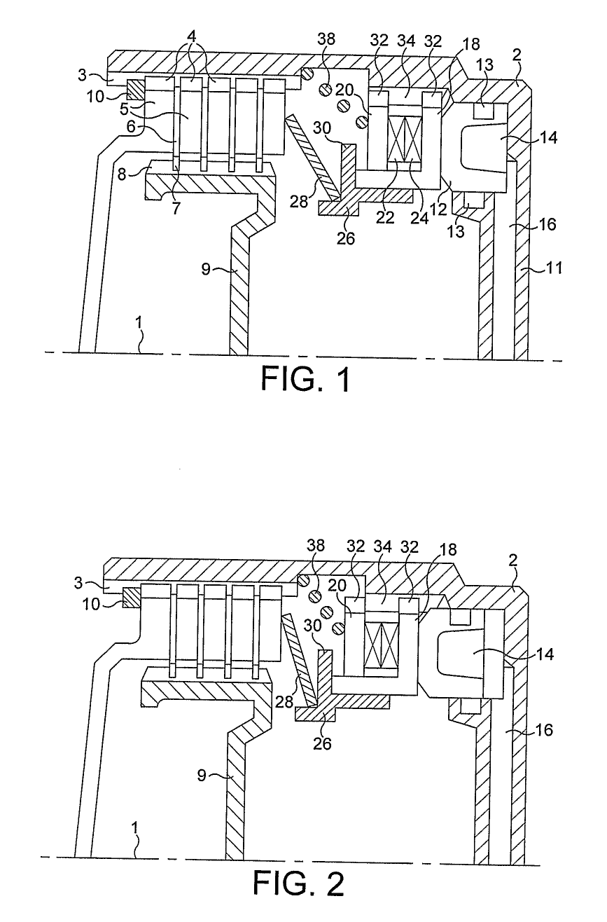

FIG. 1 is a part axial section through a clutch incorporating an actuator according to the present invention, in the disengaged condition;

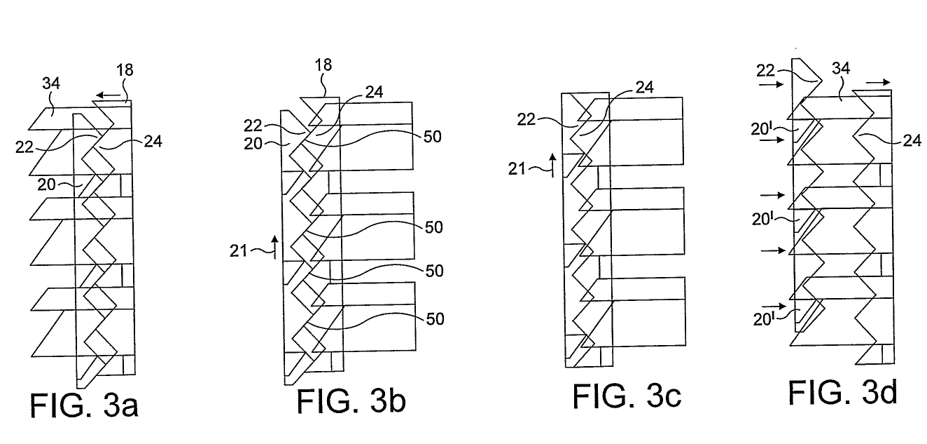

FIG. 2 corresponds to FIG. 1, and shows the actuator in the engaged condition.

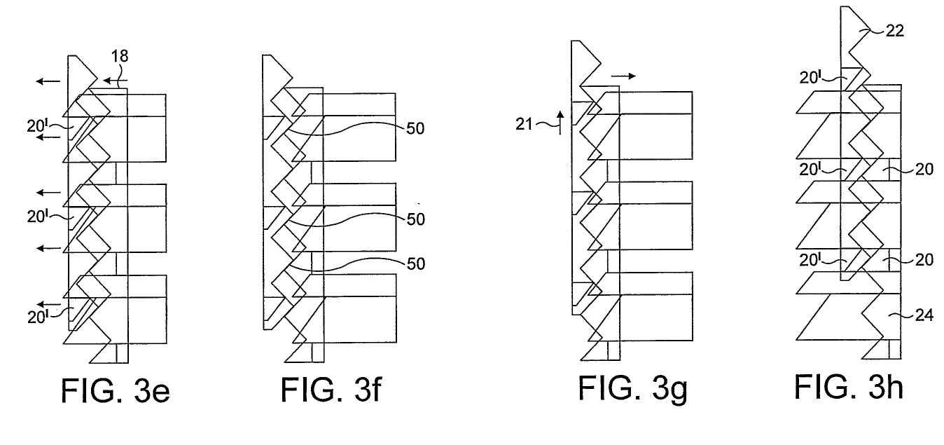

FIG. 3 comprises a series of schematic developed views of interengageable formations which define bi-stable states of the actuator of FIGS. 1 and 2.

FIGS. 1 and 2 illustrate a half-section through a wet clutch/actuator assembly which is symmetrical about an axis of rotation 1.

The clutch comprises a circular cup-like housing 2 supported for rotation about the axis of symmetry 1 by suitable bearings (not shown). The housing defines internal axially directed splines 3 for engagement with external splines (or teeth) 4 of several axially spaced annular drive plates 5. Interleaved between the drive plates 5 are annular driven plates 6 which have internal splines (or teeth) 7 for engagement with splines 8 of a circular driven member 9, also rotatable about axis 1.

A stop member 10 (for example a circlip or spring ring) is located in the open mouth of the housing 2 and thus restricts leftward movement of the plates 5, 6. It will be appreciated that the housing 2 and drive member 9 comprise input/output members for connection to suitable transmission components between which drive is to be provided. The direction of drive may of course be reversed so that the drive plates become driven plates, and vice versa.

Typically the driven plates 6 will comprise a suitable friction material for engagement with plain steel drive plates 5. However any suitable combination of materials is possible provided that adequate torque capacity is assured.

The end wall 11 of the housing 2 defines an annular chamber 14 in which an annular piston 12 is reciprocal along axis 1. The piston 12 has the usual elastomeric seals 13, and the end wall 11 is relatively thick to define a fluid conduit 16 for the chamber 14.

A latching mechanism is provided between the piston 12 and the interleaved plates 5,6. This mechanism comprises a drive ring 18 and an axially spaced latching ring 20 having a toothed engagement 22, 24 adapted to give a bi-stable state, as will be further described below. It will be observed that rings 18, 20 have external teeth 32 for engagement with splines 34 arranged around the inside of the housing 2. The rings 18, 20 are thus restrained against rotation, except in circumstances to be described.

The latching ring 20 is urged to the right (as viewed) by a frusto-conical coil compression spring 38 which reacts against a stop provided at the inner end of the splines 3.

The drive ring 18 extends leftwardly at the inner periphery to bear upon an actuating ring 26 which defines a seat for a Belleville spring 28; the other side of spring 28 bears upon the end most of the interleaved plates 5, 6 at the approximate radial centreline.

As will be appreciated, the components are assembled sequentially via the mouth of the housing 2, and are urged apart by the Belleville spring so as to seat the piston 12 in the returned condition. In the arrangement of FIG. 1, the drive ring 18 and latching ring 20 are in a first bi-stable state and relatively close together; the interleaved plates 5,6 are in light rattle-free contact, but unable to transmit significant torque. The reaction force of the Belleville spring 28 is transmitted to the housing 2 via drive ring 18 and piston 12.

The arrangement of FIG. 2 shows a second bi-stable state in which the rings 18, 20 are further to the left (as viewed). The Belleville spring 28 thus applies a significant clamping load and the plates 5,6 are adapted to transmit significant torque therebetween. The reaction force of the spring 28 is now transmitted to the housing via the latching ring 20. The drive ring 18 and piston 12 are not under load, but friction from the seals 13 tends to maintain them in a leftward position.

FIG. 3 illustrates, in developed plan, the tooth form 22, 24 of the rings 18, 20. The components are initially assumed to be in the condition of FIG. 1 (i.e. clutch disengaged). The relative tooth forms 22, 24 are as illustrated in FIG. 3(a).

On application of pressure via conduit 16, the drive ring 18 is urged leftwards (as viewed) to lift the tooth form 32 beyond the splines 34 as shown in FIG. 3 (b). At this axial extent the latching ring 20 is free to rotate and does so in the direction of arrow 21 until fully engaged with the drive ring 18, as shown in FIG. 3 (c) Rotation is by virtue of the slope of the contact point 50, and the force applied by coil spring 38.

On release of pressure in conduit 16, the Belleville spring 28 urges the actuating ring rearwardly, and in turn the latching ring 20 moves to the right until the latching ring splines 32 are engaged with spline 34, as shown in FIG. 2. At this point further rightward movement of the latching ring 20 is obstructed and the clutch plates 5,6 are maintained in an engaged condition, as shown in FIG. 2.

It will be appreciated that the force/travel characteristics of a Belleville spring can be applied with advantage, to reduce the load upon the clutch pack in the condition of FIG. 3 (b), where the latching ring 20 is urged to the left most condition. As the latching ring moves rightwards, the force applied by the Belleville spring 28 increases, and it may be arranged that a gradual increase of clamping force is assured as the clutch pack wears.

In order to release the clutch, pressure is re-applied via the conduit 16 (FIG. 3e). The latching ring 20 is again lifted clear of the splines 34 (FIG. 3f) and rotates in the direction of arrow 21 (FIG. 3g) until the latching ring splines 32 are aligned with splines 34. This allows the latching ring to return to the rest position (FIG. 3h) in which the clutch pack is disengaged and the Belleville spring 28 is substantially relaxed.

By comparison of FIGS. 3(a) and 3 (h), it will be seen that the relative axial positions are the same, but that the latching ring 20 has indexed with respect to the drive ring 18. The symmetrical continuous arrangement of the tooth forms 22, 24 facilitates endless cycling of pressure in the conduit 18 and in consequence repeated engagement and disengagement of the clutch pack 5, 6.

It will be appreciated that indexation is achieved by repeated application of pressure, and that no additional directional mechanisms are required to ensure sequential operation. Furthermore, the external envelope of the clutch can be substantially unchanged.

1. A fluid actuator comprising a housing, a fluid chamber, and an actuating member adapted to advance in the housing on an axis in response to a change of fluid pressure within said chamber, said actuator further including a bistable latch defining two sequential return positions of said actuating member, said latch switching states on advancing movement to a pre-determined position.

2. An actuator according to claim 1 and further including resilient means to bias said actuating member to a return position.

3. An actuator according to claim 1 wherein said bi-stable latch comprises an input member, an output member, and a light spring to bias said input member and output member together, wherein said input member and output member have interengaging teeth adapted to permit relative rotation by unidirectional ratcheting, each ratcheting step corresponding to one or other conditions of said bi-stable latch.

4. An actuator according to claim 1, wherein said housing is circular about said axis, and said input and output member comprise rings within said housing, said rings and housing having an anti-rotation formation and said output member being disengaged from said formation at the pre-determined position of said actuating member.

5. An actuator according to claim 4 wherein in the most retracted of said return positions said actuating member is biased against said housing via said input member, and in the most advanced of said return positions said actuating member is biased against said housing via said output member.

6. An actuator according to claim 5 and comprising a Belleville spring biasing said actuating member to the return condition, and a coil compression spring biasing said output member against said input member.

7. An actuator according to claim 4, and further comprising a clutch driven plate within said housing, said clutch driven plate having an output rotatable on said axis, being adapted to transmit torque in one state of said bistable latch, and be adapted to slip in the other state of said bi-stable latch.

8. An actuator according to claim 6 and further including a clutch pressure plate slidable in said housing, but restrained against relative rotation therein, said actuating member acting on said pressure plate via said Belleville spring.

9. An actuator according to claim 1, wherein said fluid chamber is within said housing.

10. An actuator according to claim 9 wherein said chamber includes a piston slidable therein on said axis, and adapted to urge said input member in an advancing direction.

11. An actuator according to claim 2 wherein said bi-stable latch comprises an input member, an output member, and a light spring to bias said input member and output member together, wherein said input member and output member have interengaging teeth adapted to permit relative rotation by unidirectional ratcheting, each ratcheting step corresponding to one or other conditions of said bi-stable latch.

12. An actuator according to claim 11, wherein said housing is circular about said axis, and said input and output member comprise rings within said housing, said rings and housing having an anti-rotation formation, and said output member being disengaged from said formation at the pre-determined position of said actuating member.

13. An actuator according to claim 12, wherein in the most retracted of said return positions said actuating member is biased against said housing via said input member, and in the most advanced of said return positions said actuating member is biased against said housing via said output member.

14. An actuator according to claim 13, further comprising a Belleville spring biasing said actuating member to the return condition, and a coil compression spring biasing said output member against said input member.

15. An actuator according to claim 14, and further comprising a clutch driven plate within said housing, said clutch driven plate having an output rotatable on said axis, being adapted to transmit torque in one state of said bistable latch, and be adapted to slip in the other state of said bi-stable latch.

16. An actuator according to claim 2, wherein said housing is circular about said axis, and said input and output member comprise rings within said housing, said rings and housing having an anti-rotation formation, and said output member being disengaged from said formation at the pre-determined position of said actuating member.

17. An actuator according to claim 5, and further comprising a clutch driven plate within said housing, said clutch driven plate having an output rotatable on said axis, being adapted to transmit torque in one state of said bistable latch, and be adapted to slip in the other state of said bi-stable latch.

18. An actuator according to claim 17 and further including a clutch pressure plate slidable in said housing, but restrained against relative rotation therein, said actuating member acting on said pressure plate via said Belleville spring.

19. An actuator according to claim 2, wherein said fluid chamber is within said housing.

20. An actuator according to claim 3, wherein said fluid chamber is within said housing.
